(19) United States
(12) Patent Application Publication
(10) Pub. No.: US 2009/0209157 A1
(43) Pub. Date: Aug. 20, 2009

(54) Polyolefin nanocomposites materials

(75) Inventors: Giuseppe Ferrara, Ferrara (IT); Franco Sartori, Ferrara (IT); Enrico Costantini, Ferrara (IT); Fabio Di Pietro, Ferrara (IT)

Correspondence Address: Basell USA Inc., Delaware Corporate Center II, 2 Righter Parkway, Suite #300, Wilmington, DE, 19803, US

(73) Assignee: Basell Poliolefine Italia s.r.l., Milan (IT)

(21) Appl. No.: 11/921,708

(22) PCT Filed: May 26, 2006
(86) PCT No.: PCT/EP2006/062635

§ 371 Date: Dec. 6, 2007

(30) Foreign Application Priority Data
Jun. 7, 2005 (EP) 05076323.4

(51) Int. Cl. D04H 13/00; D02G 3/00; B32B 5/16; C08L 23/00; C08J 3/22

(52) U.S. Cl. 442/327; 428/364; 428/331; 524/570; 524/528; 523/351

(57) ABSTRACT

A polyolefin nanocomposite material comprising the following components:
(A) a crystalline or semi-crystalline polyolefin resin; and
(B) a nanosize layered mineral filler,
   wherein the amount of inorganic fraction of the layer mineral filler is from 0.02 to 3 parts by weight per 100 parts by weight of polyolefin resin (A), and the ratio MFR (1)/MFR (2) of the melt flow rate value MFR (1) of component (A) to the melt flow rate value MFR (2) of the polyolefin nanocomposite material is of at least 1.02

This application is the U.S. national phase of International Application PCT/EP2006/062635, filed May 26, 2006, claiming priority to European Patent Application 05076323.4 filed Jun. 7, 2005; the disclosures of International Application PCT/EP2006/062635 and European Patent Application 05076323.4, each as filed, are incorporated herein by reference.

The present invention relates to polyolefin nanocomposite materials comprising a polyolefin and at least one nanosize mineral filler and to a process for preparing such materials. More particularly, the nanocomposite materials contain organoclays, hydrotalcite or other layered mineral fillers. It also relates to articles and particularly to fibres and films formed from said materials and to processes for the preparation of said fibres and films. More particularly, the present invention concerns fibres exhibiting a good balance of tenacity, elongation at break and softness. It also relates to films exhibiting good barrier properties, shrinkability and tear strength and optical properties.

As used herein the term “nanosize filler” means a filler with at least one dimension (length, width or thickness) in the range from about 0.2 to about 250 nanometers.

The definition of fibres includes continuous fibres, staple fibres and/or filaments produced with the spunlaid process, tapes and monofilaments.

The polyolefin fibres according to the present invention are particularly adequate for the use in cloth-like applications and hygiene products.

The definition of films includes cast, blown and biaxially oriented films, particularly biaxially oriented polypropylene films (BOPP), adequate for the use in food and tobacco packaging and tapes.

Composites comprising a polyolefin resin and a nanosize mineral filler in low amounts are already known. Efforts have been made to increase the compatibility phenomena between the said two components of different chemical nature, in order to improve the mechanical properties of the polyolefin nanocomposite material.

For example, U.S. Pat. No. 5,910,523 describes polyolefin nanocomposite materials comprising a semi-crystalline polyolefin and a nanosize mineral filler wherein the surface of the filler has been modified with functionalized compounds.

WO 01/96467 describes polyolefin nanocomposite materials comprising a graft copolymer. The preparation of the graft copolymer is carried out in the presence of an organoclay so that a significant improvement in the mechanical properties of the products is achieved.

The polyolefin composite materials used for fibres up to now, however, failed to provide polyolefin fibres with the previously said balance of performances. Moreover, the most serious problem presented by the prior art nanocomposite materials is that they are spun with difficulty.

The present invention overcomes the disadvantages associated with the use of the above mentioned polyolefin nanocomposite materials in the production of fibres, by providing a polyolefin composite material having physical-chemical properties different from those of the composite material used up to now.

A great additional advantage of the polyolefin composite material of the present invention is that the said material exhibits good drawability with an acceptable spinning behavior.

It is also known the use of polyolefin composite materials for film production.

When the filler particles have an average diameter ranging from about 0.5 to 40 μm, the polyolefin composite materials are well known to produce films particularly prone to breakages as in the European Patent n. 0659815. It is equally well known that the addition of a filler can produce voids that would increase permeability of the film if not filled with waxes as in the International Patent Application WO9903673. Thus the addition of a filler is expected to produce voids, brittleness and opaqueness of the film thereof.

When the filler is a nanosize filler it is expected to have the same effects. Particularly for bioriented films, it is still difficult to obtain a good dispersion of the nanosize filler avoiding the formation of gels or film breakages.

Films produced with the polyolefin composite material of the present invention surprisingly exhibits usual processing behavior, good optical and physical-mechanical properties and improved barrier properties.

Therefore, the present invention provides a polyolefin nanocomposite material comprising the following components:

(A) a crystalline or semi-crystalline polyolefin resin; and
(B) a nanosize filler comprising or substantially consisting of a layered mineral, preferred example of which is a layer silicate,
wherein the amount of inorganic fraction of the layered mineral, or of the layer silicate in the preferred example, is from 0.02 to 3, preferably from 0.03 to 3, parts by weight per 100 parts by weight of polyolefin resin (A), and the ratio MFR (1)/MFR (2) of the melt flow rate value MFR (1) of component (A) to the melt flow rate value MFR (2) of the polyolefin nanocomposite material is of at least 1.02, preferably of at least 1.05, more preferably of at least 1.1, even more preferably of at least 1.3, in particular from 1.02 to 2, or from 1.05, or 1.1, or 1.3, to 2.

The composite material of the present invention typically exhibits the following properties:
an increase of the flexural elastic modulus of at least from 1 to 100%, preferably from 20 to 100% with respect to the value measured on component (A);
an increase of heat distortion temperature ranging from 5 to 50° C., preferably 10-50° C., with respect to the value measured on component (A); typically the HDT of the composition is higher than 80° C. when the component (A) is polypropylene;
MFR (2) values of from 1 to 800 dg/min.

Component (A), namely the polyolefin resin, is preferably a propylene polymer that is either a propylene homopolymer or a random interpolymer of propylene with an α-olefin selected from ethylene and a linear or branched C4-C8 α-olefin, such as copolymers and terpolymers of propylene. Component (A) can also be a mixture of the said polymers, in which case the mixing ratios are not critical. Preferably, the α-olefin is selected from the group consisting of ethylene, 1-butene, 1-pentene, 1-hexene, 1-heptene, 1-octene, 1-nonene, 1-decene and 4-methyl-1-pentene. The preferred amount of comonomer content ranges from 0.5 to 15 wt %. The preferred polyolefin resin is propylene homopolymer.

The said propylene polymer exhibits a stereoregularity of the isotactic type.

Component (A) can also be advantageously selected from polyethylene and polybutene-1. When component (A) is polypropylene the crystalline or semi-crystalline polyolefin resin has an insolubility in xylene at ambient temperature, namely about 25° C., higher than 55 wt %. Component (A) has a melt flow rate value preferably varying in the range from 5 to 50 g/10 min. The polyolefin nanocomposite can also undergo chemical degradation to increase the melt flow rate. When component (A) is polyethylene it has a melt flow rate value preferably varying in the range from 0.1 to 10 g/10 min. When component (A) is polybutene-1 it has a melt flow rate value preferably varying in the range from 0.2 to 50 g/10 min.

The melt flow rate (MFR) values are measured according to the appropriate ISO 1133 method, in particular according to ISO method 1133 at 230° C., 2.16 kg for propylene polymers, and according to ISO method 1133 at 190° C., 2.16 kg for butene-1 or ethylene polymers. The said polyolefin resin is prepared by polymerization of the relevant monomers in the presence of a suitable catalyst such as a highly stereospecific Ziegler-Natta catalyst or metallocene catalyst. In particular it can be obtained by low-pressure Ziegler-Natta polymerization for example with catalysts based on TiCl₃, or halogenated compounds of titanium (in particular TiCl₄) supported on magnesium chloride, and suitable co-catalysts (in particular alkyl compounds of aluminium).

Component (B), namely the layered mineral filler, is preferably selected from nanohydrotalcite or phyllosilicates. Particularly preferred examples of such silicates are smectite clays and nanozeolites. Smectite clays include, for example, montmorillonite, saponite, beidellite, hectorite, bohemite and stevensite. Particularly clays that may be used in the present invention besides smectite clay include kaolin clay, attapulgite clay and bentonite clay. Montomorillonite clays are preferred.

The layered mineral filler and particularly the layer silicates used for the preparation of the nanocomposite materials of the present invention generally comprise an organic component fraction. The amount of organic component fraction can vary widely, and can be expressed in terms of cationic exchange capacity (CEC).

The preferred layered mineral fillers to be used for the materials of the present invention have CEC values ranging from 70 to 140, more preferably over 120 milliequivalents per 100 g of mineral filler in dehydrated form.

Preferred organic compounds to be used as organic component are ammonium organic salts, like for example dimethyl dehydrogenated tallow quaternary ammonium.

The organic compounds are introduced in the layered mineral structure instead of existing metal cations, like in particular Na⁺ and Ca++, in amounts substantially equal to the said CEC values, therefore the layered mineral used for the preparation of the nanocomposite materials of the present invention generally comprises an organic component fraction (consisting of one or more organic compounds) in amounts ranging from 70 to 140, more preferably over 120 milliequivalents per 100 g of the layered mineral in dehydrated form. In terms of weight, the amount of organic component is generally of about 45% or less with respect to the total weight of the layered mineral, wherein the mineral itself is considered in the dehydrated form. Higher contents of organic component are not excluded; in fact good results are obtained also with amounts of organic component in the range from 40 to 60% by weight.

Particularly when the layered mineral filler is a layer silicate it is preferably in an amount from 0.1 to 3 parts by weight (pw) per 100 parts by weight of polyolefin resin (A) considering only the inorganic fraction. That is an amount of mineral filler from 0.2 to 6 parts by weight per 100 parts by weight of polyolefin resin (A), when calculated considering the inorganic plus the organic component fraction of the mineral filler.

The lower range of mineral filler content (inorganic fraction), from 0.02 to 0.1 parts by weight (pw) per 100 parts by weight of polyolefin resin (A), is particularly preferred, in fiber application, when it is required maximum spinnability of the material and long spinning times without changing the filter.

All the above-mentioned amounts of layer silicate are based on the dehydrated form.

The polyolefin nanocomposite material can optionally comprise a compatibilizer to better disperse the mineral filler into the polyolefin resin. Examples of them are copolymers comprising polar monomers. The polar monomers are preferably selected from those containing at least one functional group selected from carboxylic groups and their derivatives, such as anhydrides. Examples of the aforesaid polar monomers with one or more functional groups are anhydrides of an unsaturated dicarboxylic acid, especially maleic anhydride, itaconic anhydride, citraconic anhydride and tetrahydrophthalic anhydride, fumaric anhydride, the corresponding acids and C1-C10 linear and branched dialkyl esters of said acids; maleic anhydride is preferred. Particularly preferred are grafted copolymers where the backbone polymer chain is a polymer of an olefin selected from ethylene and C3-C10 α-olefins.

The backbone polymer chain is preferably made up of the same olefin(s) as component (A). The polar monomers are generally grafted on the said polyolefin in amounts ranging from 0.4 to 1.5% by weight with respect to the total weight of the grafted polyolefin.

Comparable amounts of polar monomers in free form can also be present in addition.

An example of suitable graft copolymer is the polypropylene-g-maleic anhydride.

When present, the compatibilizer is preferably in amounts ranging from 0.5 to 15% by weight, preferably 0.5-10 wt %, with respect to the weight of the polyolefin resin component (A). Lower contents of compatibilizer are not excluded; in fact good results are obtained also with amounts of polar monomers in the range from 0.05 and 1% with respect to the weight of the polyolefin resin component (A), particularly from 0.2 to 0.4 wt %.

Further components present in the polyolefin nanocomposite material of the present invention are additives commonly employed in the art, such as antioxidants, light stabilizers, heat stabilizers, antistatic agents, flame retardants, fillers. nucleating agents, pigments, anti-soiling agents, photosensitizers.

A further embodiment of the present invention is a process for the preparation of the said polyolefin nanocomposite material.

The polyolefin nanocomposite material according to the present invention is prepared by mechanically blending polyolefin component (A), component (B) and optionally further components. such as the compatibilizer. The layered mineral component (B) can be blended to the polyolefin component (A) in pure (undiluted) form (one step process) or, preferably, as part of a masterbatch; in such a case, component (B) is previously dispersed in a polymer resin that can be same as or different from polyolefin component (A). The masterbatch thus prepared is then blended with the polymer component (A). Component (B) is preferably added to component (A) when such component (A) is in the molten state.

The nanocomposite composition according to the present invention can be prepared by using conventional equipments, such as an extruder, like a Buss extruder, a single or a twin screw extruder with length/diameter ratio over 40, or a mixer, like a Banbury mixer. Preferred extruders are equipped with screws able to generate low values of shear stress. Particularly with such extruders lower values of the length/diameter ratio are not excluded; in fact particularly good results are right obtainable with length/diameter ratio from over 15.

A way of producing the polyolefin nanocomposite material according to the present invention comprises at least the two following stages:

1) preparing a masterbatch by mixing a polyolefin resin with a layered mineral filler (B); and
2) mixing the masterbatch prepared in stage (1) with the polyolefin component (A).

The nanosize filler is preferably added to the polyolefin resin when it is in the molten state. In an extruder the filler is added with a feeder positioned after the melting of the polymer.

The compatibilizer and the above-mentioned additives can be added during either stage (1), stage (2) or both. The compatibilizer is preferably added during stage (1) before adding the layered mineral filler. The compatibilizer and the other additives are preferably components of the masterbatch and are added to component (A) when it is still in the solid state.

The said process uniformly disperses the nanocomposite in the polyolefin matrix and leads to a high degree of exfoliation of the mineral filler (B).

The amount of layered mineral filler in the masterbatch is preferably from 2 to 40% by weight, more preferably from 2 to 20% by weight of the mineral filler in dehydrated form, with respect to the total weight of the masterbatch.

The above said process stages (1) and (2) are preferably carried out under the following conditions:
a mixing temperature higher than the polymer softening temperature, in particular of at least 180° C., preferably from 180 to 200° C.;
shear mixing rate ranging from 30 to 300 sec⁻¹, preferably from 30 to 150 sec⁻¹;
residence time in mixing machine over 80 sec.

Uniform dispersion of the nanosize filler with a high degree of exfoliation of the said filler in the polyolefin matrix can be obtained also with a one step process.

The preferred one step process comprises the addition of the undiluted mineral filler component (B) directly on the molten polyolefin component (A). The compatibilizer and the other additives, that can be optionally added, are preferably added to component (A) before the said step of addition of the layered mineral filler component (B), when the polyolefin component (A) is still in the solid state.

Extrusion conditions, reported for the two stages process above, are suitable for the one step process too.

Another embodiment of the present invention is a fibre made from the above mentioned polyolefin nanocomposite material, thus comprising or substantially consisting of the said material.

Another further embodiment of the present invention is a non-woven fabric comprising the previously said fibres.

The unstretched filaments according to the present invention typically exhibit the following balance of properties: a tenacity value higher than 22 cN/tex and an elongation at break value higher than 230%. Surprisingly good softness of the said fibres is also achieved in spite of their high tenacity that is normally associated with a worsening of softness.

The polyolefin nanocomposite material used for spunbond applications or for producing partly-oriented yarn has a M̅_{w}/ M̅ₙ value, measured by GPC, typically ranging from 2 to 6, preferably from 2 to 4, and MFR ranging from 8 to 150 g/10 min, preferably from 12 to 60 g/10 min.

The polyolefin nanocomposite material for producing meltblown fibers typically has an MFR value over 100 g/10 min preferably over 400 g/10 min and a M̅_{w}/ M̅ₙ value from 2 to 10, preferably from 2 to 6.

The polyolefin nanocomposite material used for fibres in thermalbonding processes typically has a M̅_{w}/ M̅ₙ value from 2 to 10, preferably from 4 to 10 and an MFR value from 4 to 25 g/10 min, preferably from 6 to 25 g/10 min.

A still further embodiment of the present invention is a film, bioriented, blown or cast made from the above mentioned polyolefin nanocomposite material, thus comprising or substantially consisting of the said material.

Particularly preferred is a BOPP film that when produced according to the present invention typically exhibits improved barrier properties with respect to gases such as O₂, CO₂ and water vapour. Particularly an improvement of O₂ barrier activity of at least 15% is observed with respect to the reference material without nanosize filler.

Stretchability of the BOPP films according to the invention does not get worse for the addition of nanosize filler with respect to the reference material at the temperature of the stretching process.

The polyolefin nanocomposite material used for BOPP processes typically has a M̅_{w}/ M̅ₙ value from 4 to 8, and an MFR value from 1.5 to 5 g/10 min.

The particulars are given in the following examples, which are given to illustrate, without limiting, the present invention.

The following analytical methods have been used to determine the properties reported in the detailed description and in the examples.
Melt Flow Rate (MFR): According to ISO method 1133 (230° C., 2.16 kg, for polypropylene).
Fractions soluble and insoluble in xylene at 25° C.: 2.5 g of polymer are dissolved in 250 ml of xylene at 135° C. under agitation. After 20 minutes the solution is allowed to cool to 25° C., still under agitation, and then allowed to settle for 30 minutes. The precipitate is filtered with filter paper, the solution evaporated in nitrogen flow, and the residue dried under vacuum at 80° C. until constant weight is reached. Thus one calculates the percent by weight of polymer soluble and insoluble at room temperature.
Flexural elastic modulus: According to ISO 178.
Density: According to ISO 1183.
Heat Distortion Temperature (HDT): According to ISO 75.
Elongation at break: According to ISO 527.
Titre of filaments: from a 10 cm long roving, 50 fibres are randomly chosen and weighed. The total weight of the said 50 fibres, expressed in mg, is multiplied by 2, thereby obtaining the titre in dtex.
Tenacity and Elongation (at break) of filaments: from a 500 m roving a 100 mm long segment is cut. From this segment the single fibres to be tested are randomly chosen. Each single fibre to be tested is fixed to the clamps of an Instron dynamometer (model 1122) and tensioned to break with a traction speed of 20 mm/min for elongations lower than 100% and 50 mm/min for elongations greater than 100%, the initial distance between the clamps being of 20 mm. The ultimate strength (load at break) and the elongation at break are determined.
The tenacity is derived using the following equation:

Tenacity=Ultimate strength (cN) 10/Titre (dtex).
Fibre Softness: determined by touch (panel test); the softness feeling is classified in an increasing order, from “standard” (+) to “very soft” (+++).
Film Haze: According to ASTM D-1003.
Film Gloss: According to ISO 2813.
Film tensional properties (Tensional Elastic Modulus, Stress at Break, Elongation at Break, Yield strength, Elongation at Yield. Ultimate Strength): According to ISO 527-1, -2.
Number of Gels: According to ASTM D 3354-93
Coefficient of Friction (COF) of films: According to ISO/DIS 8295.
Elmendorf: According to ISO 6383-2.
Film Permeability (gas transmission rate): According to ASTM D1434-82 (2003)

### EXAMPLE 1

### Stage (1)

### Preparation of the Masterbatch

In a monoscrew Buss 70 extruder having a length/diameter ratio of 17 a masterbatch was prepared by mixing the following components:

1) 88 wt % of a polyolefin matrix consisting in an isotactic propylene homopolymer (MFR 12) produced by polymerizing propylene in the presence of a Ziegler-Natta catalyst, having a solubility in xylene at 25° C. of about 3% wt and containing a conventional stabilizer formulation for fibers;
2) 5 wt % of an organoclay marketed with the trademark Cloisite 15A by Southern Clay Products, containing 43% by weight of organic component (organic ammonium salt); and
3) 7 wt % of a maleic anhydride-g-polypropylene having 0.7 wt % of maleic anhydride grafted on the polypropylene.

The extrusion was carried out under the following conditions:
extrusion temperature: 200° C.;
residence time in the extruder: 1.5 min;
shear mixing: 100 sec¹.

### Stage (2)

### Preparation of the Polyolefin Nanocomposite Material

After the preparation of the masterbatch, in the same type of extruder as that used in process stage (1) a polyolefin nanocomposite material was prepared by mixing the following components:

1) 97 parts by weight (pw) of an isotactic propylene homopolymer of the same type as that used for the matrix in the masterbatch; and
2) 3 pw of the masterbatch previously prepared.

The extrusion took place under the same conditions as for stage (1).

### Preparation of the Fibres

The polyolefin nanocomposite material thus obtained was spun in a Leonard pilot plant to prepare continuous fibres. The spinning process was carried out at a temperature of 280° C. and at a spinning rate of 1500 m/min and constant out-put of 0.4 grams/min·hole. Then the fibre was stretched at a stretching ratio of 1:15, for a final take up speed of 2250 m/min. The maximum spinnability speed was 3900 m/min.

Table 1 reports the amounts of filler and compatibilizer in the final polyolefin nanocomposite material, and the properties of the material as such and those of fibres produced with the polyolefin nanocomposite material.

### EXAMPLE 2 AND COMPARATIVE EXAMPLE 1 (1c)

Example 1 was repeated except for the amounts of masterbatch that were changed as reported in Table 1.

TABLE 1

| Examples | | |
|---|---|---|
| 1c | 1 | 2 |

Process Step (2)

| | | | |
|---|---|---|---|
| Polyolefin homopolymer, pw | 100 | 97 | 95 |
| Masterbatch, pw | 0 | 3 | 5 |

Final polyolefin nanocomposite material

| | | | |
|---|---|---|---|
| Mineral filler, wt %* | 0 | 0.15 | 0.25 |
| Compatibilizer, wt % | 0 | 0.21 | 0.35 |
| MFR of polyolefin component (A) | 12 | 12 | 12 |
| (MFR (1)) dg/min | | | |
| MFR of polyolefin nanocomposite | — | 11 | 10 |
| material (MFR (2)), dg/min | | | |
| MFR (1)/MFR (2) ratio | — | 1.09 | 1.2 |

Properties of the nanocomposite material

| | | | |
|---|---|---|---|
| Flexural elastic modulus, MPa | 1550 | 1680 | 1730 |
| Density, g/ml | 0.905 | 0.909 | 0.910 |
| Heat Distortion Temperature, ° C. | 80 | 86 | 90 |
| Elongation at break, % | 50 | 40 | 35 |

Spinning Process

| | | | |
|---|---|---|---|
| Head Temperature ° C. | 280 | 280 | 280 |
| spinning rate m/min | 1500 | 1500 | 1500 |
| Stretching ratio | 1:1.5 | 1:1.5 | 1:1.5 |

Properties of fibres

| | | | |
|---|---|---|---|
| maximum spinnability speed m/min | 3900 | 3900 | 3900 |
| Titer, dtex | 1.90 | 1.80 | 1.75 |
| Tenacity, cN/tex | 20.5 | 23 | 25.1 |
| Elongation at break, % | 175 | 285 | 265 |
| Softness | + | +++ | +++ |

*The values of Mineral filler, wt % are calculated with respect to the final nanocomposite material weight and considering the inorganic plus the organic component fractions of the mineral filler.

### EXAMPLE 3 AND 4 AND COMPARATIVE EXAMPLE 3 (3c)

Example 1 was repeated changing the polyolefin matrix used for the preparation of the polyolefin nanocomposite material in stage (2). The polyolefin matrix used in stage (2) is an isotactic propylene homopolymer (MFR 15) produced by polymerizing propylene in the presence of a single site Metallocene catalyst, having a molecular weight distribution with a M̅_{w}/ M̅ₙ value of 3.

The amounts of masterbatch added in stage (2) were changed as reported in Table 2.

### Preparation of the Fibres

The polyolefin nanocomposite material thus obtained was spun in a Leonard pilot plant to prepare continuous fibres. The spinning process was carried out at a spinning rate of 2700 m/min and constant out-put of 0.6 grams/min-hole. The temperature is changed to tailor the spinning conditions. An increase of the maximum spinnability speed is obtained increasing the Head Temperature of the Fiber-Machine in example 4 with respect to example 3.

Table 2 reports the amounts of filler and compatibilizer in the final polyolefin nanocomposite material, spinning process conditions and the properties of the material as such and those of fibres produced with the polyolefin nanocomposite material.

TABLE 2

| Examples | | |
|---|---|---|
| 3c | 3 | 4 |

Process Step (2)

| | | | |
|---|---|---|---|
| Polyolefin homopolymer, pw | 100 | 99 | 99 |
| Masterbatch, pw | 0 | 1 | 1 |

Final polyolefin nanocomposite material

| | | | |
|---|---|---|---|
| Mineral filler, wt %* | 0 | 0.05 | 0.05 |
| Compatibilizer, wt % | 0 | 0.07 | 0.07 |
| MFR of polyolefin component (A) (MFR | 15 | 15 | 15 |
| (1)) dg/min (on pellet) | | | |
| MFR of polyolefin nanocomposite material | — | 13 | 13 |
| (MFR (2)), dg/min (on pellet) | | | |
| MFR (1)/MFR (2) ratio (on pellet) | — | 1.15 | 1.15 |

Spinning Process

| | | | |
|---|---|---|---|
| Head Temperature ° C. | 280 | 280 | 285 |
| spinning rate m/min | 2700 | 2700 | 2700 |

Properties of fibres

| | | | |
|---|---|---|---|
| maximum spinnability speed m/min | 4500 | 3000 | 4200 |
| Titer, dtex | 2.15 | 2.25 | 2.25 |
| Tenacity, cN/tex | 37.2 | 33.9 | 25.0 |
| Elongation at break, % | 280 | 235 | 230 |
| Softness | + | +++ | ++ |

*The values of Mineral filler, wt % are calculated with respect to the final nanocomposite material weight and considering the inorganic plus the organic component fractions of the mineral filler.

### EXAMPLE 5

### Stage (1)

### Preparation of the Masterbatch

In a twin-screw extruder having a length/diameter ratio of 27 a masterbatch was prepared by mixing the following components:

1) 88 wt % of a polyolefin matrix consisting in an isotactic propylene homopolymer (MFR 25) produced by polymerizing propylene in the presence of a Ziegler-Natta catalyst, having a solubility in xylene at 25° C. of about 3.5% wt and containing a conventional stabilizer formulation for fibers;
2) 5 wt % of an organoclay marketed with the trademark Cloisite 15A by Southern Clay Products, containing 43% by weight of organic component (organic ammonium salt); and
3) 7 wt % of a maleic anhydride-g-polypropylene having 0.7 wt % of maleic anhydride grafted on the polypropylene.

The extrusion was carried out under the same conditions of example 1:
extrusion temperature: 200° C.;
residence time in the extruder: 1.5 min;
shear mixing: 100 sec-1.

### Stage (2)

### Preparation of the Polyolefin Nanocomposite Material

After the preparation of the masterbatch, in the same type of extruder as that used in process stage (1) a polyolefin nanocomposite material was prepared by mixing the following components:

1) 97 parts by weight (pw) of a random copolymer of propylene containing 5% w of ethylene having a MFR of 28.4 and a solubility in xylene at 25° C. of about 11% wt and produced according to the process described in the PCT patent application WO2004/029342;
2) 3 pw of the masterbatch previously prepared.

The extrusion took place under the same conditions as for stage (1).

### Preparation of the Fibres

The polyolefin nanocomposite material thus obtained was spun in a Leonard pilot plant to prepare continuous fibres. The spinning process was carried out at a temperature of 240° C., at a spinning rate of 2700 m/min and constant out-put of 0.6 grams/min·hole.

Table 3 reports the amounts of filler and compatibilizer in the final polyolefin nanocomposite material, spinning process conditions, properties of the material as such and those of fibres produced with the polyolefin nanocomposite material.

### EXAMPLE 6 AND COMPARATIVE EXAMPLE 5 (5c)

Example 5 was repeated except for the amounts of masterbatch that were changed as reported in Table 3.

TABLE 3

| Examples | | |
|---|---|---|
| 5c | 5 | 6 |

Process Step (2)

| | | | |
|---|---|---|---|
| Polyolefin Random Copolymer, pw | 100 | 97 | 95 |
| Masterbatch, pw | 0 | 3 | 5 |

Final polyolefin nanocomposite material

| | | | |
|---|---|---|---|
| Mineral filler, wt %* | 0 | 0.15 | 0.25 |
| Compatibilizer, wt % | 0 | 0.12 | 0.35 |
| MFR of polyolefin component (A) (MFR | 28.4 | 28.4 | 28.4 |
| (1)) dg/min | | | |
| MFR of polyolefin nanocomposite material | | 27.9 | 27.2 |
| (MFR (2)), dg/min | | | |
| MFR (1)/MFR (2) ratio | | 1.02 | 1.04 |

Spinning Process

| | | | |
|---|---|---|---|
| Head Temperature ° C. | 240 | 240 | 240 |
| spinning rate m/min | 2700 | 2700 | 2700 |

Properties of fibres

| | | | |
|---|---|---|---|
| maximum spinnability speed m/min | 4500 | 4200 | 4200 |
| Titer, dtex | 2.40 | 2.45 | 2.30 |
| Tenacity, cN/tex | 25.3 | 26.0 | 25.8 |
| Elongation at break, % | 200 | 215 | 230 |

*The values of Mineral filler, wt % are calculated with respect to the final nanocomposite material weight and considering the inorganic plus the organic component fractions of the mineral filler.

### EXAMPLES 7-11 AND COMPARATIVE EXAMPLE 7 (7c)

Example 5 was repeated preparing the masterbatch in stage (1) and the nanocomposite material in stage (2) using a twin-screw extruder having a length/diameter ratio of 27. The polyolefin matrix used in both stage (1) and (2) is an isotactic propylene homopolymer (MFR 29.2), having a solubility in xylene at 25° C. of about 3.5% wt and produced by polymerizing propylene in the presence of a Ziegler-Natta catalyst.

The amount of masterbatch added in stage (2) was changed as reported in Table 4.

### Preparation of the Fibres

The polyolefin nanocomposite material thus obtained was spun in a Leonard pilot plant to prepare continuous fibres. The spinning process was carried out at a temperature of 255° C. and at a spinning rate of 2700 m/min and constant out-put of 0.6 grams/min-hole.

Table 4 reports the amounts of filler and compatibilizer in the final polyolefin nanocomposite material, the spinning process conditions, the properties of the material as such (on pellets) and those of fibres produced with the polyolefin nanocomposite material.

The nanosize filler does not affect the fibre degradation during spinning as it is observed comparing MFR values on pellets and on fibres.

TABLE 4

| Examples | | | | | |
|---|---|---|---|---|---|
| 7c | 7 | 8 | 9 | 10 | 11 |

Process Step (2)

| | | | | | | |
|---|---|---|---|---|---|---|
| Polyolefin homopolymer, pw | 100 | 99 | 98 | 96 | 92 | 50 |
| Masterbatch, pw | 0 | 1 | 2 | 4 | 8 | 50 |

Final polyolefin nanocomposite material

| | | | | | | |
|---|---|---|---|---|---|---|
| Mineral filler, wt %* | 0 | 0.05 | 0.10 | 0.20 | 0.40 | 2.5 |
| Compatibilizer, wt % | | 0.07 | 0.14 | 0.28 | 0.56 | 3.5 |
| MFR of polyolefin component (A) | 29.2 | | | | | |
| (MFR (1)) dg/min (on pellets) | | | | | | |
| MFR of polyolefin nanocomposite | | 23.4 | 20.4 | 18.5 | 18.4 | 15.0 |
| material (MFR (2)), dg/min (on | | | | | | |
| pellets) | | | | | | |
| MFR (1)/MFR (2) ratio (on pellets) | | 1.25 | 1.43 | 1.58 | 1.59 | 1.95 |

Spinning Process

| | | | | | | |
|---|---|---|---|---|---|---|
| Head Temperature ° C. | 255 | 255 | 255 | 255 | 255 | 255 |
| Spinning rate m/min | 2700 | 2700 | 2700 | 2700 | 2700 | 2700 |

Properties of fibres

| | | | | | | |
|---|---|---|---|---|---|---|
| MFR of polyolefin component (A) | 32.3 | | | | | |
| (MFR (1)) dg/min (on fibers) | | | | | | |
| MFR of polyolefin nanocomposite | | 25.7 | 22.5 | 20.6 | 19.7 | 17.6 |
| material (MFR (2)), dg/min (on | | | | | | |
| fibers) | | | | | | |
| maximum spinnability speed m/min | 4200 | 3600 | 3300 | 3300 | 3300 | 2700 |
| Titer, dtex | 2.15 | 2.30 | 2.45 | 2.35 | 2.20 | 2.45 |
| Tenacity, cN/tex | 25.7 | 22.4 | 22.6 | 22.5 | 28.4 | 19.9 |
| Elongation at break, % | 240 | 240 | 280 | 285 | 295 | 370 |

*The values of Mineral filler, wt % are calculated with respect to the final nanocomposite material weight and considering the inorganic plus the organic component fractions of the mineral filler.

### EXAMPLE 12-16 AND COMPARATIVE EXAMPLE 12 (12c)

Example 5 was repeated preparing the masterbatch in stage (1) and the nanocomposite material in stage (2) in a twin-screw extruder having a length/diameter ratio of 27. The polyolefin matrix used in both stage (1) and (2) is an isotactic propylene homopolymer (MFR 28.4) having a molecular weight distribution with a M̅_{w}/ M̅ₙ value of 3 and produced by polymerizing propylene in the presence of a single site Metallocene catalyst.

The amount of masterbatch added in stage (2) was changed as reported in Table 5.

### Preparation of the Fibres

The polyolefin nanocomposite material thus obtained was spun in a Leonard pilot plant to prepare continuous fibres. The spinning process was carried out at a temperature of 255° C. and at a spinning rate of 2700 m/min and constant out-put of 0.6 grams/min·hole.

Table 5 reports the amounts of filler and compatibilizer in the final polyolefin nanocomposite material, the spinning process conditions, the properties of the material as such and those of the fibres produced with the polyolefin nanocomposite material.

TABLE 5

| Examples | | | | | |
|---|---|---|---|---|---|
| 12c | 12 | 13 | 14 | 15 | 16 |

Process Step (2)

| | | | | | | |
|---|---|---|---|---|---|---|
| Polyolefin homopolymer, pw | 100 | 99 | 98 | 96 | 92 | 50 |
| Masterbatch, pw | 0 | 1 | 2 | 4 | 8 | 50 |

Final polyolefin nanocomposite material

| | | | | | | |
|---|---|---|---|---|---|---|
| Mineral filler, wt %* | 0 | 0.05 | 0.10 | 0.20 | 0.40 | 2.5 |
| Compatibilizer, wt % | | 0.07 | 0.14 | 0.28 | 0.56 | 3.5 |
| MFR of polyolefin component (A) | 28.4 | | | | | |
| (MFR (1)) dg/min (on pellets) | | | | | | |
| MFR of polyolefin nanocomposite | | 27.4 | 27.2 | 26.5 | 26.2 | 22.4 |
| material (MFR (2)), dg/min (on | | | | | | |
| pellets) | | | | | | |
| MFR (1)/MFR (2) ratio (on pellets) | | 1.03 | 1.04 | 1.07 | 1.08 | 1.27 |

Spinning Process

| | | | | | | |
|---|---|---|---|---|---|---|
| Head Temperature ° C. | 255 | 255 | 255 | 255 | 255 | 255 |
| spinning rate m/min | 2700 | 2700 | 2700 | 2700 | 2700 | 2700 |

Properties of fibres

| | | | | | | |
|---|---|---|---|---|---|---|
| MFR of polyolefin component (A) | 33.1 | | | | | |
| (MFR (1)) dg/min (on fibers) | | | | | | |
| MFR of polyolefin nanocomposite | | 29.9 | 30.8 | 29.3 | 27.9 | 26.5 |
| material (MFR (2)), dg/min (on | | | | | | |
| fibers) | | | | | | |
| maximum spinnability speed m/min | 4500 | 4500 | 4200 | 3600 | 3300 | 2700 |
| Titer, dtex | 2.30 | 2.45 | 2.40 | 2.35 | 2.35 | 2.40 |
| Tenacity, cN/tex | 35.6 | 31.3 | 29.2 | 26.1 | 30.6 | 23.0 |
| Elongation at break, % | 155 | 165 | 180 | 210 | 260 | 370 |

*The values of Mineral filler, wt % are calculated with respect to the final nanocomposite material weight and considering the inorganic plus the organic component fractions of the mineral filler.

### EXAMPLE 17-19 AND COMPARATIVE EXAMPLE 17 (17c)

Example 5 was repeated using:
for the preparation of the masterbatch in stage (1), a polybutene homopolymer (MFR 4) having a melting temperature of 127° C., produced by polymerizing butene-1 in the presence of a Ziegler-Natta catalyst and containing a conventional stabilizer formulation for fibers; and
for the preparation of the polyolefin nanocomposite material in stage (2), an isotactic propylene homopolymer (MFR 25) having a solubility in xylene at 25° C. of about 3.9% wt, produced by polymerizing propylene in the presence of a Ziegler-Natta catalyst.

The amount of masterbatch added in stage (2) was changed as reported in Table 6.

The extrusion was carried out in stage (1) and (2) in a twin screw extruder as in example 5 under the following conditions:
extrusion temperature: 180° C.;
residence time in the extruder: 1.5 min;
shear mixing: 100 sec⁻¹.

### Preparation of the Fibres

The polyolefin nanocomposite material thus obtained was spun in a Leonard pilot plant to prepare continuous fibres. The spinning process was carried out at a temperature of 250° C. and .at a spinning rate of 2700 m/min and constant out-put of 0.6 grams/min·hole.

Table 6 reports the amounts of filler and compatibilizer in the final polyolefin nanocomposite material, the spinning process conditions, the properties of the material as such and those of fibres produced with the polyolefin nanocomposite material.

TABLE 6

| Examples | | | |
|---|---|---|---|
| 17c | 17 | 18 | 19 |

Process Step (2)

| | | | | |
|---|---|---|---|---|
| Polyolefin homopolymer, pw | 100 | 99 | 98 | 96 |
| Masterbatch, pw | 0 | 1 | 2 | 4 |

Final polyolefin nanocomposite material

| | | | | |
|---|---|---|---|---|
| Mineral filler, wt %* | 0 | 0.05 | 0.10 | 0.20 |
| Compatibilizer, wt % | | 0.07 | 0.14 | 0.28 |

Spinning Process

| | | | | |
|---|---|---|---|---|
| Head Temperature ° C. | 250 | 250 | 250 | 250 |
| spinning rate m/min | 2700 | 2700 | 2700 | 2700 |

Properties of fibres

| | | | | |
|---|---|---|---|---|
| MFR of polyolefin component (A) | 29.5 | | | |
| (MFR (1)) dg/min (on fibers) | | | | |
| MFR of polyolefin nanocomposite | | 23.8 | 21.0 | 20.0 |
| material (MFR (2)), dg/min (on | | | | |
| fibers) | | | | |
| MFR (1)/MFR (2) ratio (on fibers) | | 1.24 | 1.40 | 1.48 |
| maximum spinnability speed | 4500 | 3600 | 3600 | 2700 |
| m/min | | | | |
| Titer, dtex | 2.30 | 2.35 | 2.45 | 2.40 |
| Tenacity, cN/tex | 24.1 | 28.1 | 28.8 | 33.4 |
| Elongation at break, % | 240 | 255 | 255 | 265 |

*The values of Mineral filler, wt % are calculated with respect to the final nanocomposite material weight and considering the inorganic plus the organic component fractions of the mineral filler.

### EXAMPLE 20-22 AND COMPARATIVE EXAMPLE 20 (20c)

Example 17 was repeated using:
the same polybutene homopolymer as in example 17 for the preparation of the masterbatch in stage (1); and
an isotactic propylene homopolymer (MFR 25) produced by polymerizing propylene in the presence of a single site Metallocene catalyst, having a molecular weight distribution with a M̅_{w}/ M̅ₙ value of 3, for the preparation of the polyolefin nanocomposite material in stage (2). The amount of masterbatch added in stage (2) was changed as reported in Table 7.

The extrusion in stage (1) and (2) was carried out in the same conditions of example 17

### Preparation of the Fibres

The polyolefin nanocomposite material thus obtained was spun in a Leonard pilot plant to prepare continuous fibres. The spinning process was carried out at a temperature of 250° C. and at a spinning rate of 2700 m/min and constant out-put of 0.6 grams/min·hole.

Table 7 reports the amounts of filler and compatibilizer in the final polyolefin nanocomposite material, the spinning process conditions, the properties of the material as such and those of fibres produced with the polyolefin nanocomposite material.

TABLE 7

| Examples | | |
|---|---|---|
| 20c | 20 | 20 |

Process Step (2)

| | | | |
|---|---|---|---|
| Polyolefin homopolymer, pw | 100 | 98 | 96 |
| Masterbatch, pw | 0 | 2 | 4 |

Final polyolefin nanocomposite material

| | | | |
|---|---|---|---|
| Mineral filler, wt %* | 0 | 0.10 | 0.20 |
| Compatibilizer, wt % | | 0.14 | 0.28 |

Spinning Process

| | | | |
|---|---|---|---|
| Head Temperature ° C. | 250 | 250 | 250 |
| spinning rate m/min | 2700 | 2700 | 2700 |

Properties of fibres

| | | | |
|---|---|---|---|
| MFR of polyolefin component (A) | 31.8 | | |
| (MFR (1)) dg/min (on fibers) | | | |
| MFR of polyolefin nanocomposite | | 30.4 | 27.3 |
| material (MFR (2)), dg/min (on fibers) | | | |
| MFR (1)/MFR (2) ratio (on fibers) | | 1.05 | 1.16 |
| maximum spinnability speed m/min | 4200 | 3300 | 2300 |
| Titer, dtex | 2.30 | 2.25 | 2.40 |
| Tenacity, cN/tex | 37.3 | 24.0 | 21.9 |
| Elongation at break, % | 170 | 180 | 235 |

*The values of Mineral filler, wt % are calculated with respect to the final nanocomposite material weight and considering the inorganic plus the organic component fractions of the mineral filler.

### EXAMPLE 21-23 AND COMPARATIVE EXAMPLE 21 (21c)

Example 17 was repeated using:
the same polybutene homopolymer used in example 17 both for the preparation of the masterbatch in stage (1); and for the preparation of the polyolefin nanocomposite material in stage (2).

The amount of masterbatch added in stage (2) was changed as reported in Table 8.

The extrusion in stage (1) and (2) was carried out in the same conditions of example 17

### Preparation of the Fibres

The polyolefin nanocomposite material thus obtained was spun in a Leonard pilot plant to prepare continuous fibres. The spinning process was carried out at a temperature of 210° C. and .at a spinning rate of 2700 m/min and constant out-put of 0.6 grams/min·hole.

Table 8 reports the amounts of filler and compatibilizer in the final polyolefin nanocomposite material, the spinning process conditions, the properties of the material as such and those of fibres produced with the polyolefin nanocomposite material.

TABLE 8

| Examples | | | |
|---|---|---|---|
| 21c | 21 | 22 | 23 |

Process Step (2)

| | | | | |
|---|---|---|---|---|
| Polyolefin homopolymer, pw | 100 | 99 | 98 | 96 |
| Masterbatch, pw | 0 | 1 | 2 | 4 |

Final polyolefin nanocomposite material

| | | | | |
|---|---|---|---|---|
| Mineral filler, wt %* | 0 | 0.05 | 0.10 | 0.20 |
| Compatibilizer, wt % | | 0.07 | 0.14 | 0.28 |

Spinning Process

| | | | | |
|---|---|---|---|---|
| Head Temperature ° C. | 210 | 210 | 210 | 210 |
| spinning rate m/min | 2700 | 2700 | 2700 | 2700 |

Properties of fibres

| | | | | |
|---|---|---|---|---|
| MFR of polyolefin component (A) | 66.0 | | | |
| (MFR (1)) dg/min (on fiber) | | | | |
| MFR of polyolefin nanocomposite | | 64.0 | 64.0 | 54.2 |
| material (MFR (2)), dg/min (on | | | | |
| fiber) | | | | |
| MFR (1)/MFR (2) ratio (on fiber) | | 1.03 | 1.03 | 1.22 |
| maximum spinnability speed | 4200 | 4200 | 3600 | 3900 |
| m/min | | | | |
| Titer, dtex | 2.45 | 2.50 | 2.50 | 2.50 |
| Tenacity, cN/tex | 18.5 | 20.5 | 20.0 | 24.4 |
| Elongation at break, % | 25 | 33 | 38 | 51 |

*The values of Mineral filler, wt % are calculated with respect to the final nanocomposite material weight and considering the inorganic plus the organic component fractions of the mineral filler.

### EXAMPLE 24

### Stage (1)

### Preparation of the Masterbatch

In a twin-screw extruder having a length/diameter ratio of 27 a masterbatch was prepared by mixing the following components:

1) 88 wt % of a polyolefin matrix consisting in an isotactic propylene homopolymer produced by polymerizing propylene in the presence of a Ziegler-Natta catalyst, having a solubility in xylene at 25° C. of about 4% wt and containing a conventional stabilizer formulation, with a MFR 1.8 (dg/min);
2) 5 wt % of an organoclay marketed with the trademark Cloisite 15A by Southern Clay Products, containing 43% by weight of organic component (organic ammonium salt); and
3) 7 wt % of a maleic anhydride-g-polypropylene having 0.7 wt % of maleic anhydride grafted on the polypropylene.

The extrusion was carried out under the following conditions:
extrusion temperature: 210° C.;
residence time in the extruder: 2 min;
shear mixing: 150 sec⁻¹.

### Stage (2)

### Preparation of the Polyolefin Nanocomposite Material

After the preparation of the masterbatch, in the same type of extruder as that used in process stage (1) a polyolefin nanocomposite material was prepared by mixing the following components:

1) 95 parts by weight (pw) of an isotactic propylene homopolymer of the same type as that used for the matrix in the masterbatch; and
2) 5% pw of the masterbatch previously prepared.

The extrusion took place under the same conditions as for stage (1).

### Preparation of the BOPP Film

The polyolefin nanocomposite material thus obtained was compression moulded on a CARVER machine at 200° C. to obtain a plaque 1 mm thick and 60×60 mm and then have been stretched using TM-Long machine at an oven temperature of 150° C. with a stretching ratio of 7×7 in both directions to obtain a BOPP film 21-23 μm thick

Table 9 reports the amount of nano-filler in the final polyolefin nanocomposite material and the properties of the BOPP film produced with the polyolefin nanocomposite material.

### EXAMPLE 25 AND COMPARATIVE EXAMPLE 24 (24c)

Example 24 was repeated except for the amounts of masterbatch that were changed as reported in Table 9.

Table 9b reports the gas barrier properties measured on the BOPP films.

TABLE 9

| Examples | | |
|---|---|---|
| 24c | 24 | 25 |

Process Step (2)

| | | | |
|---|---|---|---|
| Polyolefin homopolymer, pw | 100 | 99 | 95 |
| Masterbatch, pw | 0 | 1 | 5 |

Final polyolefin nanocomposite material

| | | | |
|---|---|---|---|
| Mineral filler, wt %* | 0 | 0.05 | 0.25 |
| Compatibilizer, wt % | | | |
| MFR of polyolefin component (A) (MFR | 1.80 | | |
| (1)) dg/min (on pellet) | | | |
| MFR of polyolefin nanocomposite material | | 1.70 | 1.55 |
| (MFR (2)), dg/min (on pellet) | | | |
| MFR (1)/MFR (2) ratio (on pellet) | | 1.06 | 1.16 |

Stretching Process

| | | | |
|---|---|---|---|
| Temperature ° C. | 150 | 150 | 150 |

Properties of the BOPP film

| | | | |
|---|---|---|---|
| Thickness, μm | 22.0 | 21.0 | 23.0 |
| Haze % | 0.6 | 0.4 | 0.5 |
| Gloss 60° % | 93.0 | 92.5 | 91.1 |
| Tensional Elastic Modulus, MPa | 2400.0 | 2480.0 | 2471.0 |
| Stress at Break, MPa | 118.0 | 133.0 | 134.0 |
| Elongation at Break, % | 29.0 | 37.0 | 34.0 |

*The values of Mineral filler, wt % are calculated with respect to the final nanocomposite material weight and considering the inorganic plus the organic component fractions of the mineral filler.

TABLE 9b

| Examples | | |
|---|---|---|
| 24c | 24 | 25 |

Gas Barrier Properties of the BOPP film

| | | | |
|---|---|---|---|
| film thickness, μm | 22 | 21 | 23 |
| O₂ Transmission Rate, cc/m² 24 h | 1945 | 1937 | 1596 |
| (T = 25° C., RH = 0%) | | | |

### EXAMPLE 26

### One Step Process

In a twin-screw extruder having a length/diameter ratio of 27 a nanocomposite material was prepared by mixing the following components:

1) 99.3 wt % of a polyolefin matrix consisting in a high density PE (HDPE) produced by polymerizing ethylene in the presence of a Ziegler-Natta catalyst in a Slurry process, having a density 0.957 g/cm3 (ISO 1183) and a MFR 0.38 (230° C./5 Kg, ISO 1133) and containing a conventional stabilizer formulation.
2) 0.3% wt % of an organoclay marketed with the trademark Cloisite 15A by Southern Clay Products, containing 43% by weight of organic component (organic ammonium salt); and
3) 0.4 wt % of a copolymer of ethylene with acrylic acid and buthyl acrilate having 4 wt % of acrylic acid and 7 wt % of buthyl acrilate copolymerized with polyethylene.

The extrusion was carried out under the following conditions:
extrusion temperature: 200° C.;
residence time in the extruder: 2 min;
shear mixing: 150 sec¹.

### Preparation of the Blown Film

The polyolefin nanocomposite material thus obtained was extruded in a classical Blown film machine with a die diameter of 80 mm and a die gap of 1.2 mm at 220° C. of melt Temperature with a Blown-up ratio of 4:1, with 20° C. cooling air temperature to obtain a 100 μm thick film.

Table 10 reports the Blown Film properties.

### COMPARATIVE EXAMPLE 26 (26c)

Example 26 was repeated except that the nanosize filler was not added as reported in Table 10.

TABLE 10

| Examples | |
|---|---|
| 26c | 26 |

Final polyolefin nanocomposite material (one step process)

| | | |
|---|---|---|
| Polyolefin homopolymer, wt % | 100 | 99.3 |
| Mineral filler, wt %* | 0 | 0.3 |
| Compatibilizer, wt % | | 0.4 |
| MFR of polyolefin component (A) | 0.38 | |
| (MFR (1)) dg/min (on pellet) | | |
| MFR of polyolefin nanocomposite | | 0.35 |
| material (MFR (2)), dg/min | | |
| (on pellet) | | |
| MFR (1)/MFR (2) ratio (on pellet) | | 1.09 |

Properties of the blown film

| Thickness, μm | 100 | | 100 | |
|---|---|---|---|---|
| Gels (total amount), Nr/m² | 630 | | 220 | |
| Haze, % | 88.6 | | 87.2 | |
| Gloss 60°T.B. % | 4.7 | | 5.2 | |
| Coefficient of Friction, Nr | 0.29 | | 0.26 | |
| | MD** | TD*** | MD** | TD*** |
| Elmendorf, N | 0.47 | 8.90 | 0.33 | 10.3 |
| Yield strength, N/mm² | 25.6 | 23 | 26.2 | 23.9 |
| Elongation at yield, % | 10 | 10 | 11 | 33 |
| Ultimate Strenght, N/mm² | 31.5 | 28.8 | 28.2 | 24.6 |
| Elongation at Break, % | 722 | 990 | 717 | 670 |
| Tensional Elastic Modulus, MPa | 871 | 1256 | 937 | 1350 |

*The values of Mineral filler, wt % are calculated with respect to the final nanocomposite material weight and considering the inorganic plus the organic component fractions of the mineral filler
**Values measured in machine direction (MD)
***Values measured in cross (transverse) direction (TD).

### EXAMPLE 27 AND COMPARATIVE EXAMPLE 27 (27c)

### One Step Process

In a twin-screw extruder having a length/diameter ratio of 27 a nanocomposite material was prepared by mixing the following components:

1) 99.4 wt % of a polyolefin matrix consisting in an high density PE (HDPE) produced by polymerizing ethylene in the presence of a Ziegler-Natta catalyst in a Slurry process, having a density 0.946 g/cm³ (ISO 1183) and a MFR 1.8 (230° C./5 Kg, ISO 1133) and containing a conventional stabilizer formulation.
2) 0.3% wt % of an organoclay marketed with the trademark Cloisite 15A by Southern Clay Products, containing 43% by weight of organic component (organic ammonium salt); and
3) 0.3 wt % of a copolymer of ethylene with acrylic acid and buthyl acrilate having 4 wt % of acrylic acid and 7 wt % of buthyl acrilate copolymerized with polyethylene.

The extrusion was carried out under the following conditions:
extrusion temperature: 190° C.;
residence time in the extruder: 2 min;
shear mixing: 200 sec⁻¹.

### Preparation of the Cast Film

The polyolefin nanocomposite material thus obtained was extruded in a classical Cast film machine with a die length of 50 mm and at 210° C. of melt Temperature with a Chill-roll temperature of 50° C. and an air knife cooling at 15° C. to obtain a 50 μm thick film.

Table 11 reports the Cast film properties.

### COMPARATIVE EXAMPLE 27 (27c)

Example 27 was repeated except that the nanosize filler was not added as reported in Table 11.

TABLE 11

| Examples | |
|---|---|
| 27c | 27 |

Final polyolefin nanocomposite material (one step process)

| | | |
|---|---|---|
| Polyolefin homopolymer, wt % | 100 | 99.4 |
| Mineral filler, wt %* | 0 | 0.3 |
| Compatibilizer, wt % | | 0.3 |
| MFR of polyolefin component (A) | 1.80 | |
| (MFR (1)) dg/min (on pellet) | | |
| MFR of polyolefin nanocomposite | | 1.65 |
| material (MFR (2)), dg/min | | |
| (on pellet) | | |
| MFR (1)/MFR (2) ratio (on pellet) | | 1.09 |

Properties of the cast film

| Thickness, μm | 50 | | 50 | |
|---|---|---|---|---|
| Gels (total amount), Nr/m² | 860 | | 760 | |
| Haze, % | 26.1 | | 24.5 | |
| Gloss 60° % | 38.3 | | 42.9 | |
| Coefficient of Friction, Nr | 0.38 | | 0.39 | |
| | MD** | TD*** | MD** | TD*** |
| Elmendorf, N | 0.60 | 1.13 | 0.33 | 10.30 |
| Yield strength, N/mm² | 18.8 | 19.8 | 19.9 | 17.4 |
| Elongation at yield, % | 15 | 9 | 16 | 12 |
| Ultimate Strenght, N/mm² | 40.8 | 35.4 | 35.1 | 34 |
| Elongation at Break, % | 1700 | 1700 | 1490 | 1570 |
| Tensional Elastic Modulus, MPa | 550 | 665 | 665 | 796 |

*The values of Mineral filler, wt % are calculated with respect to the final nanocomposite material weight and considering the inorganic plus the organic component fractions of the mineral filler
**Values measured in machine direction (MD)
***Values measured in cross (transverse) direction (TD).

### EXAMPLE 28

### One Step Process

In a twin-screw extruder having a length/diameter ratio of 27 a nanocomposite material was prepared by mixing the following components:

1) 97.6 wt % of a polyolefin matrix consisting in an isotactic propylene homopolymer produced by polymerizing propylene in the presence of a Ziegler-Natta catalyst, having a solubility in xylene at 25° C. of about 4% wt and containing a conventional stabilizer formulation, with a MFR/L 1.8 (dg/min);
2) 1 wt % of an organoclay marketed with the trademark Cloisite 15A by Southern Clay Products, containing 43% by weight of organic component (organic ammonium salt); and
3) 1.4 wt % of a maleic anhydride-g-polypropylene having 0.7 wt % of maleic anhydride grafted on the polypropylene.

The extrusion was carried out under the following conditions:
extrusion temperature: 220° C.;
residence time in the extruder: 2 min;
shear mixing: 200 sec⁻¹.

### Preparation of the BOPP Film

The polyolefin nanocomposite material thus obtained was compression moulded on a CARVER machine at 200° C. to obtain a plaque 1 mm thick and 60×60 mm and then have been stretched using TM-Long machine at an oven temperature of 150° C. with a stretching ratio of 7×7 in both directions to obtain a BOPP film 21-23 μm thick.

Table 12 reports the amount of nanosize filler in the final polyolefin nanocomposite material and the properties of the BOPP film produced with the polyolefin nanocomposite material.

### EXAMPLE 29 AND COMPARATIVE EXAMPLE 28 (28c)

Example 28 was repeated except for the amounts of masterbatch that were changed as reported in Table 12.

Table 12b reports the gas barrier properties measured on BOPP films of different thickness as reported in the table.

TABLE 12

| Examples | | |
|---|---|---|
| 28c | 28 | 29 |

Final polyolefin nanocomposite material (one step process)

| | | | |
|---|---|---|---|
| Polyolefin homopolymer, wt % | 100 | 97.6 | 88 |
| Mineral filler, wt %* | 0 | 1 | 5 |
| Compatibilizer, wt % | | 1.4 | 7 |
| MFR of polyolefin component (A) | 1.80 | | |
| (MFR (1)) dg/min (on pellet) | | | |
| MFR of polyolefin nanocomposite | | 1.45 | 1.40 |
| material (MFR (2)), dg/min (on pellet) | | | |
| MFR (1)/MFR (2) ratio (on pellet) | | 1.24 | 1.29 |

Stretching Process

| | | | |
|---|---|---|---|
| Temperature ° C. | 150 | 150 | 150 |

Properties of the BOPP film

| | | | |
|---|---|---|---|
| Thickness, μm | 22.0 | 20.0 | 20.0 |
| Haze % | 0.6 | 2.0 | 2.5 |
| Gloss 60° % | 93.0 | 90.5 | 87.8 |
| Tensional Elastic Modulus, MPa | 2390.0 | 2452.0 | 2622.0 |
| Stress at Break, MPa | 115.0 | 135.0 | 130.0 |
| Elongation at Break, % | 28.0 | 43.0 | 47.0 |

*The values of Mineral filler, wt % are calculated with respect to the final nanocomposite material weight and considering the inorganic plus the organic component fractions of the mineral filler

TABLE 12b

| Examples | | |
|---|---|---|
| 28c | 28 | 29 |

Gas Barrier Properties of the BOPP film

| | | | | |
|---|---|---|---|---|
| film thickness, μm | 22 | 19* | 19 | 19 |
| O₂ Transmission Rate, cc/m² | 1250 | 1447 | 1218 | 843 |
| 24 h (T = 25° C., RH = 0%) | | | | |
| H₂O Transmission Rate, | 6.57 | 7.61 | 6.13 | 5.41 |
| gr/m² 24 h | | | | |
| (T = 38° C., RH = 90%) | | | | |
| CO₂ Transmission Rate, cc/m² | 7520 | 8700 | 6660 | 4563 |
| 24 h (T = 25° C., RH = 0) | | | | |

*Values for the 19 μm thick film are calculated from the 22 μm thick film data.

### EXAMPLE 30

### One Step Process

In a twin-screw extruder having a length/diameter ratio of 27 a nanocomposite material was prepared by mixing the following components:

1) 99.3 wt % of a polyolefin matrix consisting in an isotactic propylene homopolymer produced by polymerizing propylene in the presence of a Ziegler-Natta catalyst, having a solubility in xylene at 25° C. of about 3% wt and containing a conventional stabilizer formulation, with a MFR 11 (dg/min);
2) 0.3 wt % of an organoclay marketed with the trademark Cloisite 15A by Southern Clay Products, containing 43% by weight of organic component (organic ammonium salt); and
3) 0.4 wt % of a maleic anhydride-g-polypropylene having 0.7 wt % of maleic anhydride grafted on the polypropylene.

The extrusion was carried out under the following conditions:
extrusion temperature: 200° C.;
residence time in the extruder: 2 min;
shear mixing: 150 sec⁻¹.

### Preparation of the Cast Film

The polyolefin nanocomposite material thus obtained was extruded in a classical Cast film machine with a die length of 50 mm and at 220° C. of melt Temperature with a Chill-roll temperature of 20° C. and an air knife cooling at 15° C. to obtain 50 μm thick film.

Table 13 reports the nanocomposite Cast Film properties.

### COMPARATIVE EXAMPLE 30 (30c)

Example 30 was repeated except that the nanosize filler was not added as reported in Table 13.

TABLE 13

| Examples | |
|---|---|
| 30c | 30 |

Final polyolefin nanocomposite material (one step process)

| | | |
|---|---|---|
| Polyolefin homopolymer, wt % | 100 | 99.3 |
| Mineral filler, wt %* | 0 | 0.3 |
| Compatibilizer, wt % | | 0.4 |
| MFR of polyolefin component (A) | 11.0 | |
| (MFR (1)) dg/min (on pellet) | | |
| MFR of polyolefin nanocomposite | | 10.2 |
| material (MFR (2)), dg/min | | |
| (on pellet) | | |
| MFR (1)/MFR (2) ratio (on pellet) | | 1.08 |

Properties of the cast film

| Thickness, μm | 50 | | 50 | |
|---|---|---|---|---|
| Gels (total amount), Nr/m² | 90 | | 85 | |
| Haze, % | 15 | | 14 | |
| Gloss 60° % | 50 | | 51 | |
| Coefficient of Friction, Nr | 0.69 | | 0.65 | |
| | MD** | TD*** | MD** | TD*** |
| Elmendorf, N | 0.70 | 2.93 | 0.51 | 1.57 |
| Yield strength, N/mm² | 16.0 | 16.0 | 18.4 | 17.4 |
| Elongation at yield, % | 13 | 10 | 17 | 7 |
| Ultimate Strenght, N/mm² | 37.8 | 28.2 | 32.2 | 23.9 |
| Elongation at Break, % | 730 | 780 | 726 | 710 |
| Tensional Elastic Modulus, MPa | 535 | 585 | 588 | 636 |

*The values of Mineral filler, wt % are calculated with respect to the final nanocomposite material weight and considering the inorganic plus the organic component fractions of the mineral filler
**Values measured in machine direction (MD)
***Values measured in cross (transverse) direction (TD).

1. A polyolefin nanocomposite material comprising the following components:
(A) a crystalline or semi-crystalline polyolefin resin comprising a melt flow rate MFR (1); and
(B) a nanosize filler comprising a layered mineral, the layered mineral comprising an amount of an inorganic fraction,
wherein the polyolefin nanocomposite material comprises a melt flow rate MFR (2), the amount of inorganic fraction of the layered mineral is from 0.02 to 3 parts by weight per 100 parts by weight of polyolefin resin (A), and the ratio MFR (1)/MFR (2) is at least 1.02.

2. The polyolefin nanocomposite material according to claim 1 wherein component (B) is a layer silicate.

3. The polyolefin nanocomposite material according to claim 1 wherein the amount of inorganic fraction of the layered mineral is from 0.03 to 3 parts by weight per 100 parts by weight of polyolefin resin (A).

4. The material of claim 1 further comprising a compatibilizer selected from grafted polyolefins.

5. A process for the preparation of a polyolefin nanocomposite material comprising the following components:
(A) a crystalline or semi-crystalline polyolefin resin comprising a melt flow rate MFR (1); and
(B) a nanosize filler comprising a layered mineral, the layered mineral comprising an amount of an inorganic fraction,
wherein the polyolefin nanocomposite material comprises a melt flow rate MFR (2), the amount of inorganic fraction of the layered mineral is from 0.02 to 3 parts by weight per 100 parts by weight of polyolefin resin (A), and the ratio MFR (1)/MFR (2) is at least 1.02,
the process comprising the following stages:
1) preparing a masterbatch by mixing a polymer resin with the nanosize mineral filler (B); and
2) mixing the masterbatch prepared in stage 1) with the polyolefin component (A).

6. The process according to claim 5 wherein the nanosize mineral filler (B) is added to the polyolefin resin when it is in the molten state.

7. A process for the preparation of a polyolefin nanocomposite material comprising the following components:
(A) a molten crystalline or semi-crystalline polyolefin resin comprising a melt flow rate MFR (1); and
(B) a nanosize filler comprising a layered mineral, the layered mineral comprising an amount of an inorganic fraction,
wherein the polyolefin nanocomposite material comprises a melt flow rate MFR (2), the amount of inorganic fraction of the layered mineral is from 0.02 to 3 parts by weight per 100 parts by weight of polyolefin resin (A), and the ratio MFR (1)/MFR (2) is at least 1.02,
the process comprising one step of addition of the undiluted mineral filler (B) directly on the molten polyolefin component (A).

8. Fibres comprising a polyolefin nanocomposite material comprising the following components:
(A) a crystalline or semi-crystalline polyolefin resin comprising a melt flow rate MFR (1); and
(B) a nanosize filler comprising a layered mineral, the layered mineral comprising an amount of an inorganic fraction,
wherein the polyolefin nanocomposite material comprises a melt flow rate MFR (2), the amount of inorganic fraction of the layered mineral is from 0.02 to 3 parts by weight per 100 parts by weight of polyolefin resin (A), and the ratio MFR (1)/MFR (2) is at least 1.02.

9. Non-woven fabric comprising fibres, the fibres comprising a polyolefin nanocomposite material comprising the following components:
(A) a crystalline or semi-crystalline polyolefin resin comprising a melt flow rate MFR (1); and
(B) a nanosize filler comprising a layered mineral, the layered mineral comprising an amount of an inorganic fraction,
wherein the polyolefin nanocomposite material comprises a melt flow rate MFR (2), the amount of inorganic fraction of the layered mineral is from 0.02 to 3 parts by weight per 100 parts by weight of polyolefin resin (A), and the ratio MFR (1)/MFR (2) is at least 1.02.

10. Films comprising a polyolefin nanocomposite material comprising the following components:
(A) a crystalline or semi-crystalline polyolefin resin comprising a melt flow rate MFR (1); and
(B) a nanosize filler comprising a layered mineral, the layered mineral comprising an amount of an inorganic fraction,
wherein the polyolefin nanocomposite material comprises a melt flow rate MFR (2), the amount of inorganic fraction of the layered mineral is from 0.02 to 3 parts by weight per 100 parts by weight of polyolefin resin (A), and the ratio MFR (1)/MFR (2) is at least 1.02.
